(19) United States
(12) Patent Application Publication
(10) Pub. No.: US 2003/0221758 A1
(43) Pub. Date: Dec. 4, 2003

(54) Tire

(76) Inventor: Shut Chen Hsu, I Lan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/157,149

(22) Filed: May 30, 2002

(51) Int. Cl. B60C 17/00

(52) U.S. Cl. 152/165; 152/516

(57) ABSTRACT

A tire having two inward lips respectively protruded from two opposite sidewalls of the body thereof at an inner side adapted for supporting the tire in shape when the tire damaged accidentally, the inward lips each having a corrugated bottom sidewall, two opposite lateral sidewalls, and a plurality of air holes transversely extended through the lateral sidewalls.

### BACKGROUND OF THE INVENTION

1. Field of the Invention

The present invention relates to vehicle tires and, more particularly, to a vehicle tire, which supports the tire for normal functioning for a length time when the tire damaged accidentally.

2. Description of the Related Art

For a safety driving, the condition of vehicle tires must be regularly checked. There are two kinds of vehicle tires used in existing motorcars, namely, the tire having an inner tube, and the tire without inner tube. According to conventional tire designs, a meshed metal wire structure formed of transverse metal wires and a longitudinal metal wires is arranged in between the carcass and the tread. The two layers of metal wires are arranged at 17˜26°. This meshed metal wire structure can only reinforce the structural strength of the tire. It cannot protect the tire against piercing of an external sharp object. When a nail or the like pierced through the open spaces in the meshed metal wire structure, the tire leaks, and a tire explosion accident may occur.

### SUMMARY OF THE INVENTION

The present invention has been accomplished to provide a tire, which eliminates the aforesaid problems. According to one aspect of the present invention, the tire comprises two inward lips respectively protruded from two opposite sidewalls of the body thereof at an inner side adapted for supporting the tire in shape when the tire damaged accidentally, the inward lips each having a corrugated bottom sidewall, two opposite lateral sidewalls, and a plurality of air holes transversely extended through the lateral sidewalls. The inward lips may be reinforced with reinforcing wires or the like.

### BRIEF DESCRIPTION OF THE DRAWINGS

FIG. 1 is a sectional elevation of a tire constructed according to the present invention.

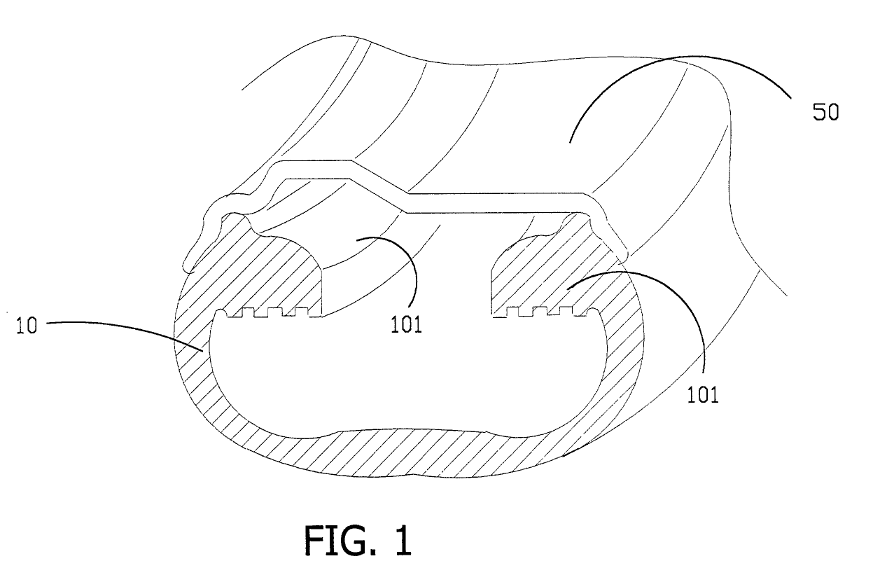

FIG. 2 is another sectional elevation of the tire according to the present invention.

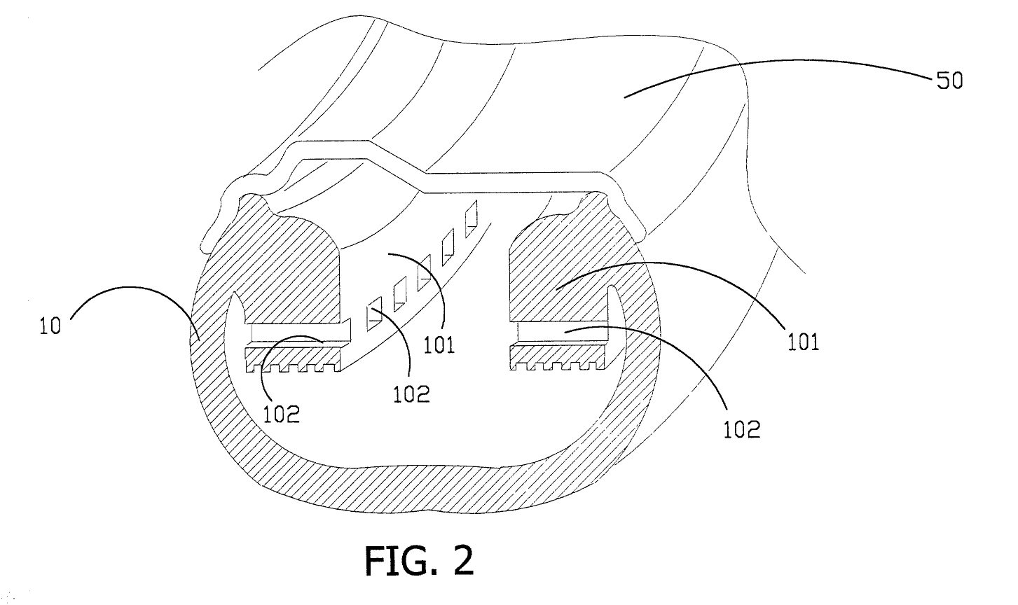

FIG. 3 is similar to FIG. 2 but air exhausted from the tire.

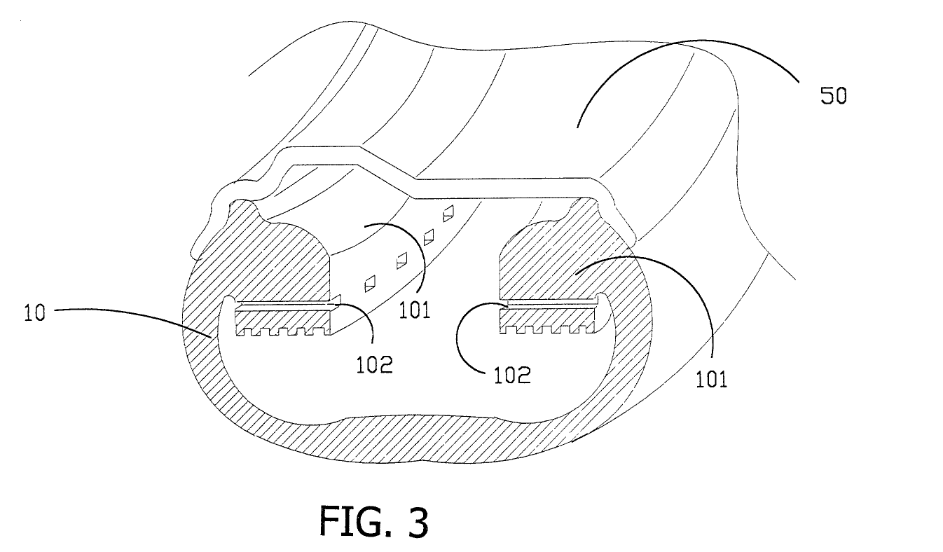

FIG. 4 shows the tire fastened to a wheel rim according to the present invention.

FIG. 5 is similar to FIG. 4 but showing air exhausted from the tire.

### DETAILED DESCRIPTION OF THE PREFERRED EMBODIMENT

Referring to FIGS. from 1 through 3, the tire 10 comprises two inward lips 101 respectively inwardly protruded from the two opposite sidewalls thereof. The inward lips 101 have a bottom sidewall corrugated, and a plurality of air holes 103 transversely extended through two opposite lateral sidewalls thereof that facilitate ventilation and diminish the weight of the tire 10.

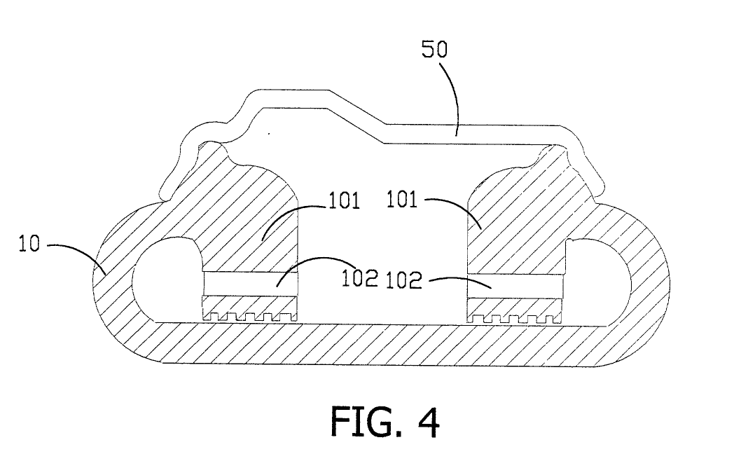

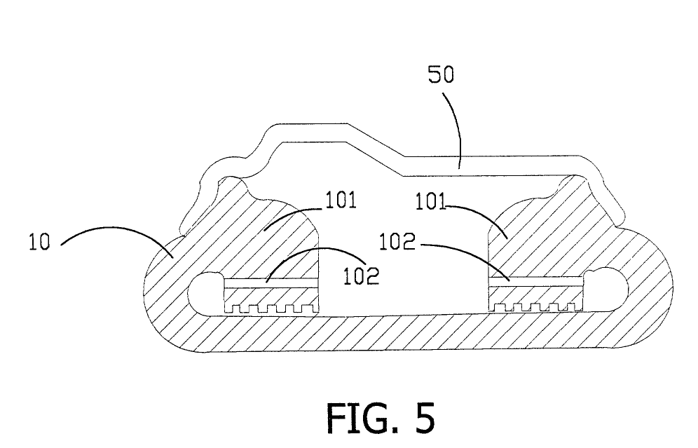

Referring to FIGS. 4 and 5, the tire 10 is fastened to a wheel rim 50, forming with the wheel rim 50 a vehicle tire. In case the tire 10 exploded due to an accident, the inward lips 101 support the tire 10 in shape, enabling the car to be continuously driven to the repair shop safely to receive a repair.

It is to be understood that the drawings are designed for purposes of illustration only, and are not intended for use as a definition of the limits and scope of the invention disclosed.

What the invention claimed is:

1. A tire comprising a tire body, said tire comprising two inward lips respectively protruded from two opposite sidewalls thereof at an inner side, said inward lips each having a corrugated bottom sidewall, two opposite lateral sidewalls, and a plurality of air holes transversely extended through said lateral sidewalls.
